(19) United States
(12) Patent Application Publication
(10) Pub. No.: US 2025/0237384 A1
(43) Pub. Date: Jul. 24, 2025

(54) WATER HEATER

(71) Applicant: KYUNGDONG NAVIEN CO., LTD., Pyeongtaek-si (KR)

(72) Inventors: Jun Kyu Park, Seoul (KR); Hyoung Rae Kim, Seoul (KR); Ho Hyun Yu, Seoul (KR)

(21) Appl. No.: 19/022,579

(22) Filed: Jan. 15, 2025

(30) Foreign Application Priority Data
Jan. 19, 2024 (KR) 10-2024-0008919

(51) Int. Cl. F23N 1/08; F23D 14/02; F23L 7/00; F24H 1/00

(52) U.S. Cl. CPC F23N 1/082; F23D 14/02; F23L 7/005; F24H 1/0036; F23N 2233/06; F23N 2237/22

(57) ABSTRACT

Disclosed is a water heater including a case provided with an air supply hole and an air discharge hole, a burner provided in an interior of the case, and a humidified air supply part that provides humidified air to the burner together with a fuel. The humidified air supply part includes a first accommodation tank that accommodates water to generate vapor, and a humidified air supply tank that provides a space for supplying the vapor supplied from the first accommodation tank to air introduced into an interior of the case through the air supply hole.

### CROSS-REFERENCE TO RELATED APPLICATION

This application claims the benefit of priority to Korean Patent Application No. 10-2024-0008919, filed in the Korean Intellectual Property Office on Jan. 19, 2024, the entire contents of which are incorporated herein by reference.

### TECHNICAL FIELD

The present disclosure relates to a water heater.

### BACKGROUND

A water heater is a device that transfers heat generated through a combustion reaction to water and uses it for heating or supplying hot water. A process of introducing water, and heating and discharging the introduced water is performed through the water heater.

The combustion reaction may be caused in a burner, and a fuel is required for the burner to cause the combustion reaction. As the fuel flows into the burner, it has a good state to form flames, and an ignition may occur, resulting in the flames along with the combustion reaction.

Meanwhile, when a combustion reaction is caused in a burner, nitrogen oxides (NOx) may be generated, and the nitrogen oxides may be contaminants that cause air pollution. Accordingly, there is an increasing need for a water heater capable of reducing nitrogen oxides emitted from the burner.

### SUMMARY

The present disclosure has been made to solve the above-mentioned problems occurring in the prior art while advantages achieved by the prior art are maintained intact.

An aspect of the present disclosure provides a water heater that may reduce nitrogen oxides discharged from a burner.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a water heater includes a case provided with an air supply hole and an air discharge hole, a burner provided in an interior of the case, and a humidified air supply part that provides humidified air to the burner together with a fuel, and the humidified air supply part includes a first accommodation tank that accommodates water to generate vapor, and a humidified air supply tank that provides a space for supplying the vapor supplied from the first accommodation tank to air introduced into an interior of the case through the air supply hole.

The humidified air supply part may further include an ultrasonic vibrator that applies ultrasonic waves to the water in the first accommodation tank.

The water heater may further include a processor that, controls an intensity of an operation of the ultrasonic vibrator to generate the vapor in proportion to a calorie generated due to the burner in response that the water is sensed in the first accommodation tank.

The humidified air supply part may further include a second accommodation tank disposed on an upper side of the first accommodation tank, and that supplements the water to the first accommodation tank.

The humidified air supply part may further include a water level adjusting valve provided in the first accommodation tank and that senses and adjust a level of the water in the first accommodation tank, and an opening/closing device that opens and closes an outlet of the second accommodation tank, the outlet communicating with the first accommodation tank and, the opening/closing device may be operated to supplement the water from the second accommodation tank to the first accommodation tank in response that the level of the water sensed by the water level adjusting valve is less than a first height.

The humidified air supply part may further include a water level sensing sensor provided in the second accommodation tank, and that senses a level of the water in the second accommodation tank, a supply pipeline communicating with the second accommodation tank at first end of the supply pipeline, and a supply valve provided at a second end of the supply pipeline, and that supplies the water to the supply pipeline, and, the processor may control the supply valve to supply water to the second accommodation tank through the supply pipeline in response that the level of the water sensed by the water level sensing sensor is less than a second height.

The humidified air supply tank may be disposed on an upper side of the first accommodation tank on one side of the second accommodation tank and the humidified air supply tank may further include a fuel supply part that receives the humidified air from the humidified air supply tank and supply the air and the fuel to the burner, and the humidified air supply part may further include a humidified air supply pipe extending from the humidified air supply tank to the fuel supply part.

The humidified air supply tank may define a humidified air communication hole communicating with the humidified air supply pipe, and an air introduction hole spaced apart from the humidified air communication hole and extending to surround the humidified air communication hole.

The humidified air supply tank may further include a cover rib defining a circumference of the air introduction hole and protruding upward from an upper surface of the humidified air supply tank.

The humidified air supply part may further include an upper flange disposed on a lower side of the second accommodation tank and on a lower side of the humidified air supply tank and integrally formed with the second accommodation tank and the humidified air supply tank, and the first accommodation tank may further include a lower flange that supports the upper flange while facing the upper flange.

The humidified air supply part may further include a first sealing member provided between the upper flange and the lower flange, and that seals the upper flange and the lower flange therebetween.

The lower flange may define a first sealing member groove formed between an inner circumference and an outer circumference of the lower flange, and recessed downward such that the first sealing member is inserted into the first sealing member groove.

The humidified air supply part may further include a tank cover disposed on an upper side of the second accommodation tank and covering the second accommodation tank, and a second sealing member disposed between the tank cover and the second accommodation tank, and that seals the tank cover and the second accommodation tank therebetween.

The tank cover may include a cover flange that is coupled to the second accommodation tank, and the second accommodation tank may include a fixing flange that supports the cover flange while facing the cover flange.

The fixing flange may define a second sealing member groove formed between an inner circumference and an outer circumference of the fixing flange, and recessed downward such that the second sealing member is inserted into the second sealing member groove.

An air guide hole for introducing the air introduced into the case may be formed in the humidified air supply pipe.

The water heater may further include a fuel supply part that receives the humidified air from the humidified air supply tank and supply the air and the fuel to the burner, and the fuel supply part may be formed by a venturi pipe.

The water heater may further include a mixing chamber disposed between the fuel supply part and the burner, and that mixes the fuel and the air, a blower fan housing disposed between the fuel supply part and the mixing chamber, and a blower fan mounted in an interior of the blower fan housing such that the fuel and the air flow from the fuel supply part to the mixing chamber.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a water heater according to an embodiment of the present disclosure;

FIG. 2 is a front view illustrating internal components of a water heater, from which a front cover is omitted, according to an embodiment of the present disclosure;

FIG. 3 is a perspective view of a humidified air supply part, a fuel supply part, and a blower fan housing of a water heater according to an embodiment of the present disclosure;

FIG. 4 is a side view of a humidified air supply part, a fuel supply part, and a blower fan housing of a water heater according to an embodiment of the present disclosure;

FIG. 5 is an exploded perspective view of a first accommodation tank, a second accommodation tank, a tank cover, and peripheral components of a humidified air supply part according to an embodiment of the present disclosure;

FIG. 6 is a plan view of a second accommodation tank, to which a tank cover of a humidified air supply part is coupled, according to an embodiment of the present disclosure;

FIG. 7 is a perspective view of a first accommodation tank, a second accommodation tank, a supply pipeline, and a supply valve of a humidified air supply part according to an embodiment of the present disclosure;

FIG. 8 is a flowchart of an operation of supplementing water to a first accommodation tank and a second accommodation tank according to an embodiment of the present disclosure; and

FIG. 9 is a flowchart of an operation of controlling an operation intensity of an ultrasonic vibrator according to an embodiment of the present disclosure.

### DETAILED DESCRIPTION

Hereinafter, some embodiments of the present disclosure will be described in detail with reference to the accompanying drawings. In the drawings, the same reference numerals will be used throughout to designate the same or equivalent components. In describing embodiments of the present disclosure, detailed descriptions associated with well-known functions or configurations will be omitted if they may make subject matters of the present disclosure unnecessarily obscure.

In the specification, a forward/rearward direction, a leftward/rightward direction, and an upward/downward direction are referred for convenience, and may be directions that are perpendicular to each other. In the specification, a horizontal direction and an upward/downward direction are referred for convenience, and may be directions that are perpendicular to each other. However, the directions are determined relatively to a direction, in which the components of a water heater are arranged, and the upward/downward direction necessarily mean a vertical direction.

Additionally, terms including ordinal numbers, such as “first,” “second,” etc., used herein may be used to describe various components, but the components are not limited by the terms, and the terms are used only for the purpose of distinguishing one component from another. For example, without departing from the scope and spirit of the present disclosure, a first component may be referred to as a second component, and similarly, the second component may be referred to as the first component. The term “and/or” includes any combination of a plurality of related listed items or any one of the plurality of related listed items.

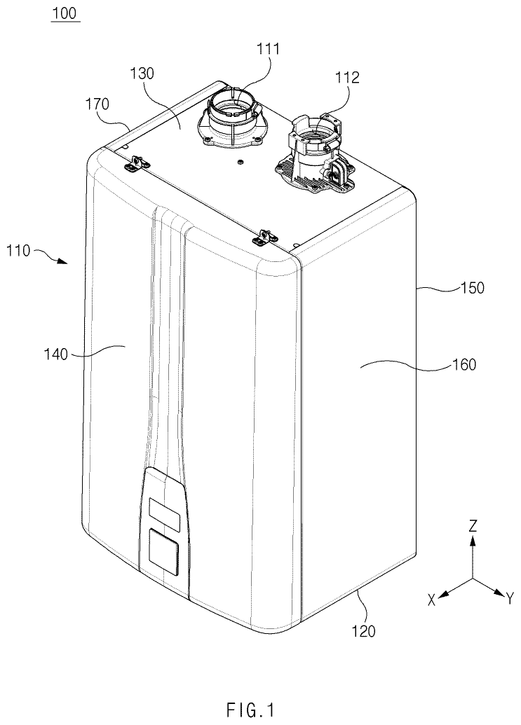

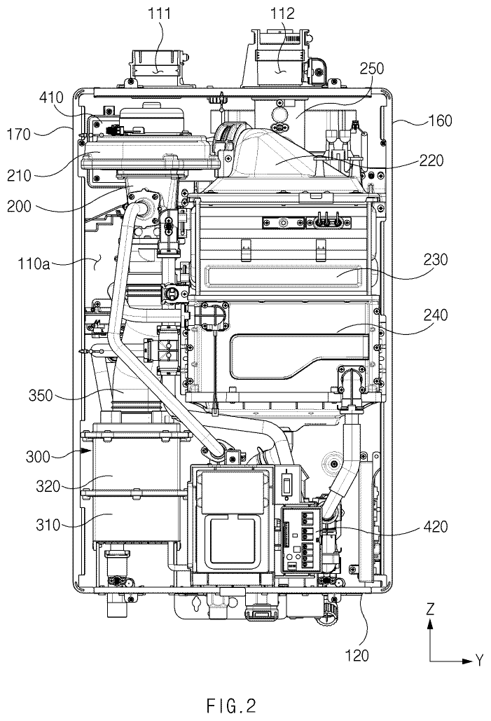

FIG. 1 is a perspective view of a water heater according to an embodiment of the present disclosure. FIG. 2 is a front view illustrating internal components of a water heater, from which a front cover is omitted, according to an embodiment of the present disclosure.

Referring to FIGS. 1 and 2, a water heater 100 according to an embodiment of the present disclosure may cover a fuel supply part 200, a blower fan housing 210, a mixing chamber 220, a burner 230, a heat exchange part 240, an exhaust pipe 250, a humidified air supply part 300, and first and second control panels 410 and 420. The above-described components of the water heater 100 may be covered by a case 110 and may be accommodated in an accommodation space 110a.

The water heater 100 may include a case 110 that is provided with an air supply hole 111 and an air discharge hole 112. The case 110 may include a lower cover 120 that covers a lower side (an opposite direction to the “Z” direction) of the accommodation space 110a, an upper cover 130 that covers an upper side (the “Z” direction) of the accommodation space 110a, a front cover 140 that covers a front side (the “X” direction) of the accommodation space 110a, and a rear cover 150 that covers a rear side (an opposite direction to the “X” direction) of the accommodation space 110a.

The case 110 may include a right cover 160 that covering a right side (the “Y” direction) of the accommodation space 110a and a left cover 170 that covers a left side (an opposite direction to the “Y” direction) of the accommodation space 110a.

The water heater 100 may be configured to heat and discharge water that is introduced into the water heater 100. To heat the water, the water heater 100 may cause a combustion reaction and transfer heat generated from the combustion reaction to water.

The water heater 100 may include a burner 230 and a heat exchange part 240 that are provided in an interior of the case 110. The burner 230 causes a combustion reaction. Accordingly, the burner 230 may receive a fuel and air, and may form flames in a mixture of the fuel and the air by using an ignition plug to cause the combustion reaction.

Heat and combustion gas are generated by the combustion reaction in the burner 230, and the heat and the combustion gas may be transferred to the water. The fuel may be a natural gas that is used for power generation, including methane, ethane, and the like, or may be oil, but the kind thereof is not limited thereto. The flames that are formed due to the combustion reaction caused by the burner 230 may be disposed in an interior space of the combustion chamber located on a lower side of the burner 230. The combustion chamber may be a wet-type combustion chamber. For example, a water pipe, through which the water passes, may be disposed on a side surface of the combustion chamber to surround a circumference of a side surface of the combustion chamber. In a process of dissipating the heat in the interior of the combustion chamber to the outside of the combustion chamber, some heat may be transferred to the water in the water pipe.

However, the type of combustion chamber is not limited to a wet combustion chamber, and may have various modifications including a dry combustion chamber.

For the heat generated by the burner 230 to be transferred to the water, the heat exchange part 240 is disposed. The heat exchange part 240 may be disposed on a lower side of the burner 230.

Meanwhile, the heat exchange part 240 may have an integral heat exchanger structure. The integral heat exchanger structure may mean a heat exchanger structure, in which different types of heat exchange media circulate. As the heat exchange part 240 has an integrated heat exchanger structure, the heat exchange part 240 may have a structure, in which an overall height thereof is lowered while maintaining performance compared to a heat exchanger used in a general condensing boiler.

Accordingly, the overall height of the water heater 100 may be lowered. Accordingly, various components may be easily disposed in an interior of the air heater 100, and the size of the entire water heater 100 may be reduced.

The heat exchange part 240 may include a sensible heat exchanger and a latent heat exchanger. The sensible heat exchanger and the latent heat exchanger may be a fin-tube type heat exchanger including a fin and a tube, through which water flows, or a plate heat exchanger that is formed by stacking a plurality of plates, but the type is not limited thereto.

For the above-described combustion operation, air may be introduced from the outside into the accommodation space 110a through an air supply hole 111, and may be supplied to the burner 230 together with the fuel. The water heater 100 may include a blower fan (not illustrated) for blowing the air, a fuel nozzle for injecting the fuel, and an ignition plug for generating a spark for ignition.

The water heater 100 may include a fuel supply part 200, a blower fan housing 210, and a mixing chamber 220. The fuel supply part 200 may be configured to supply the fuel and the air to the burner 230. The blower fan housing 210 may be disposed on an upper side of the fuel supply part 200 to communicate with the fuel supply part 200. The mixing chamber 220 may be provided between the fuel supply part 200, and the blower fan housing 210 and the burner 230 to mix the fuel and the air, and may be configured to transfer a mixture of the fuel and the air to the burner 230.

Separately from the blower fan provided in an interior of the blower fan housing 210, a blower fan may be mounted on the fuel supply part 200. When the fuel and the air are supplied through the fuel supply part 200, the blower fan provided in the interior of the blower fan housing 210 may be operated so that the fuel and the air may flow into the mixing chamber 220, and may be supplied to the burner 230 while the fuel and the air are mixed in the mixing chamber 220.

The blower fan housing 210 may be disposed between the fuel supply part 200 and the mixing chamber 220. A blower fan (not illustrated) may be mounted in the interior of the blower fan housing 210. That is, the water heater 100 may include a blower fan that causes the fuel and the air to flow from the fuel supply part 200 to the mixing chamber 220.

Meanwhile, exhaust gas may be generated due to the combustion reaction in the burner 230, and the exhaust gas may be exhausted to the outside of the air discharge hole 112 through the exhaust pipe 250. In this case, the exhaust gas includes nitrogen oxide (NOx), and the nitrogen oxide causes air pollution.

The water heater 100 according to an embodiment of the present disclosure may include a humidified air supply part 300 to reduce a concentration of the nitrogen oxide in the exhaust gas. The humidified air supply part 300 may be disposed on a lower side of the fuel supply part 200 to supply the humidified air to the fuel supply part 200. The humidified air supply part 300 may be configured to provide the humidified air to the burner 230 together with the fuel.

The humidified air supply part 300 may include a first communication tank 310 that is configured to receive water to generate water vapor in an interior of the case 110, and a humidified air supply tank 330 that is configured to provide a space for supplying the water vapor supplied from the first communication tank 310 to the air introduced into the case 110 through the air supply hole 111.

The fuel supply part 200 may be configured to receive the humidified air from the humidified air supply tank 330 and supply the air and the fuel to the burner 230. That is, the fuel supply part 200 may be supplied with the air in the accommodation space 110a having an increased humidity via the humidified air supply part 300, separately from the fuel. Thereafter, the air and the fuel may be mixed in the mixing chamber 220 via the blower fan housing 210 that communicates with the fuel supply part 200 and may be supplied to the burner 230.

Meanwhile, the fuel supply part 200 may be formed by a venturi tube so that the fuel is suctioned into the blower fan housing 210 together as the air is suctioned. However, the present disclosure is not limited thereto, and the fuel supply part 200 may control the flows of the fuel and the air, respectively.

In more detail, the reason why the air humidified through the humidified air supply part 300 is supplied to the fuel supply part 200 may be that, when the fuel and the humidified air are supplied when the combustion reaction is caused in the burner 230, the temperature of the flames, at which the combustion reaction is caused in the burner 230, may be lowered, and nitrogen oxides may be reduced as the flame temperature is lowered.

The humidified air supply part 300 may include a first accommodation tank 310, a humidified air supply tank 330 that is disposed on an upper side of the first accommodation tank 310 and receives the humidified air from the first accommodation tank 310, and a humidified air supply pipe 350 that connects the humidified air supply tank 330 and the fuel supply part 200. More detailed configurations of the humidified air supply part 300 will be described below.

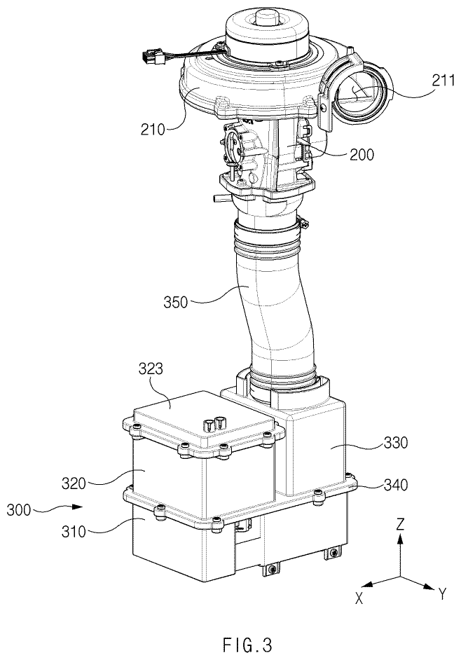

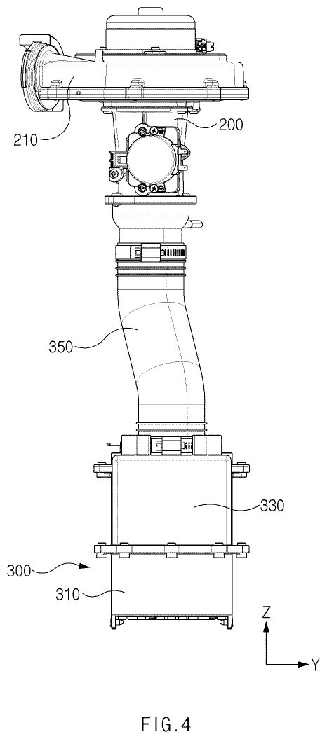

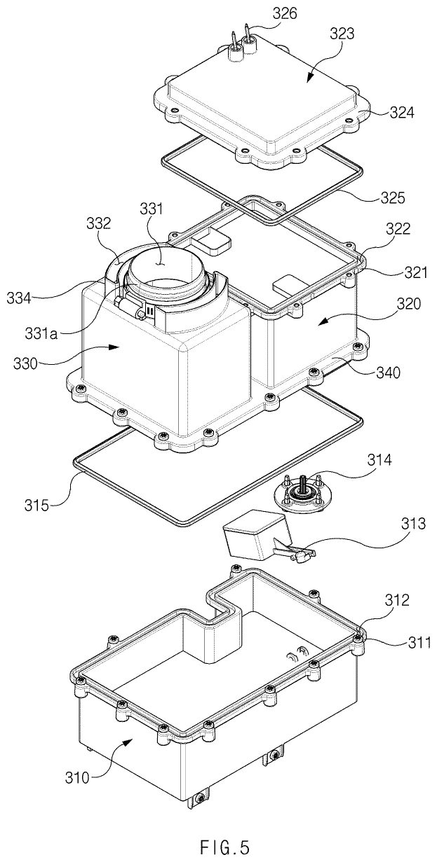

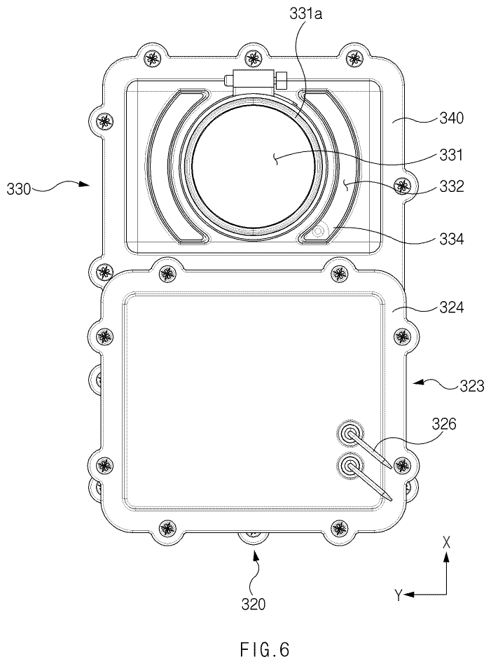

FIG. 3 is a perspective view of a humidified air supply part, a fuel supply part, and a blower fan housing of a water heater according to an embodiment of the present disclosure. FIG. 4 is a side view of a humidified air supply part, a fuel supply part, and a blower fan housing of a water heater according to an embodiment of the present disclosure. FIG. 5 is an exploded perspective view of a first accommodation tank, a second accommodation tank, a tank cover, and peripheral components of a humidified air supply part according to an embodiment of the present disclosure. FIG. 6 is a plan view of a second accommodation tank, to which a tank cover of a humidified air supply part is coupled, according to an embodiment of the present disclosure.

Referring to FIGS. 3 to 6, the humidified air supply part 300 may include a first accommodation tank 310 that is configured to accommodate water, a second accommodation tank 320 that is disposed on an upper side of the first accommodation tank 310, and a humidified air supply tank 330.

The second accommodation tank 320 may be disposed on an upper side of the first accommodation tank 310, and may be provided to supplement the water in the first accommodation tank 310 when the water is insufficient in the first accommodation tank 310.

That is, the humidified air supply part 300 may include a water level adjusting valve 313 that is provided in an interior of the first accommodation tank 310 and is configured to sense and control a level of the water level in the first accommodation tank 310, and an opening/closing device 314 that opens and closes an outlet that communicates with the first accommodation tank 310 of the second accommodation tank 320.

The opening/closing device 314 may be operate to supplement the water from the second accommodation tank 320 to the first accommodation tank 310 when the level of the water, which is sensed by the water level adjusting valve 313, is less than a specific first height.

In more detail, when the level of the water in the first accommodation tank 310, which is sensed by the water level adjusting valve 313, is less than the first height, the opening/closing device 314 may open an outlet of the second accommodation tank 320 to supplement the water from the second accommodation tank 320 to the first accommodation tank 310.

Meanwhile, when the level of the water in the first accommodation tank 310, which is sensed by the water level adjusting valve 313, is the first height or more, the opening/closing device 314 may close the outlet of the second accommodation tank 320 so that the water is not supplemented from the second accommodation tank 320 to the first accommodation tank 310.

The humidified air supply part 300 may include an ultrasonic vibrator (not illustrated) that is provided in the first accommodation tank 310 and generates water vapor by applying ultrasonic waves to the water in the first accommodation tank 310. An operation intensity of the ultrasonic vibrator may be adjusted by a processor of a first control panel 410 (see FIG. 2). A plurality of ultrasonic vibrators may be provided to meet the size of the first accommodation tank 310.

The humidified air supply tank 330 may include a humidified air supply tank 330 that is disposed on an upper side the first accommodation tank 310 on one side of the second accommodation tank 320 in the horizontal direction. The humidified air supply tank 330 may be a space for introducing the air in the accommodation space 110a and mixing it with the water vapor generated in the first accommodation tank 310. The humidified air supply tank 330 may be configured to cause the air introduced into the case 110 through the air supply hole 111 (see FIG. 1) and the water vapor generated in the first accommodation tank 310 to flow into the fuel supply part 200.

Meanwhile, the first accommodation tank 310 may have a height of at least 10 cm or more. This structure may be a structure for preventing water molecules that are larger than water vapor particles from flowing into the humidified air supply tank 330 as vibrations is applied to the water in the first accommodation tank 310 by the ultrasonic vibrator so that the water molecules is prevented from contacting the air in the humidified air supply tank 330. This is because, when the air introduced into the humidified air supply tank 330 from the accommodation space 110a contacts the water molecules that are larger than the water vapor particles, a concentration of oxygen in the air may change and thus, the performance according to the combustion reaction in the burner 230 (see FIG. 2) may change.

Furthermore, the humidified air supply tank 330 may define a humidified air communication hole 331 that communicates with the humidified air supply pipe 350, and an air introduction hole 332 that is spaced apart from the humidified air communication hole 331 and extends to surround the humidified air communication hole 331.

However, the air introduction hole 332 is not limited to being formed on the upper surface of the humidified air supply tank 330, but may be formed on a side surface of the humidified air supply tank 330.

The humidified air communication hole 331 may be formed in a circular shape when viewed from the top. The air introduction hole 332 may extend to surround the humidified air communication hole 331 on an outside of the humidified air communication hole 331 when viewed from the top and extend along a circumference of a circle. The air introduction holes 332 may be disposed on opposite sides of the humidified air communication hole 331, respectively, and may be provided as a pair.

The air introduced into the interior of the humidified air supply tank 330 through the air introduction hole 332 may serve as an air curtain to prevent the water vibrated by the ultrasonic vibrator in the first accommodation tank 310 from flowing into the humidified air supply pipe 350.

The humidified air supply tank 330 may include a supply pipe coupling part 331a that defines an outer circumference of the humidified air communication hole 331 and is coupled to the humidified air supply pipe 350.

The humidified air supply tank 330 may include a cover rib 334 that defines a circumference of the air introduction hole 332 and protrudes upward from an upper surface of the humidified air supply tank 330. The cover rib 334 may protrudes upward to introduce the air in the accommodation space 110a into the humidified air supply tank 330, and at the same time, prevent the water vibrated by the ultrasonic vibrator in the first accommodation tank 310 from being discharged to an outside of the humidified air supply tank 330 through the air introduction hole 332. The cover rib 334 may protrude upward by at least about 2 cm from the upper surface of the humidified air supply tank 330.

In this way, the air in the accommodation space 110a and the water vapor generated in the first accommodation tank 310 may be introduced into the humidified air supply tank 330 to supply the air having an increased humidity to the fuel supply part 200 through the humidified air supply pipe 350. The humidified air supply pipe 350 may extend from an upper side of the humidified air supply tank 330 to the fuel supply part 200.

The humidified air supply pipe 350 may be formed to be flexible. A diameter of the humidified air supply pipe 350 may be formed as large as possible to be connected to the humidified air supply tank 330 on a limited area of the humidified air supply tank 330. Because water vapor or fine water particles may flow into the humidified air supply pipe 350, the diameter of the humidified air supply pipe 350 may be formed large so that air is smoothly supplied to the fuel supply part 200 even when the water vapor is condensed on an inner wall of the humidified air supply pipe 350.

The humidified air supply pipe 350 may be separably coupled to or integrally formed with the humidified air supply tank 330.

Furthermore, as illustrated in the drawing, an air guide hole (not illustrated) for introducing the air introduced into the case 110 (see FIG. 1) may be formed in the humidified air supply pipe 350. Unlike the structure, in which the air introduction hole 332 is formed in the humidified air supply tank 330, the air guide hole may be a configuration for introducing air in the case 110 into the humidified air supply pipe 350.

The air guide hole may be formed on a side surface of the air supply pipe 350.

That is, in other words, as illustrated in the drawings, when the air introduction hole 332 is formed in the humidified air supply tank 330, the air may flow into the humidified air supply tank 330 through the air introduction hole 332 and flow into the humidified air supply pipe 350 together with the water vapor. The water vapor then may be suctioned directly from the humidified air supply tank 330 to the humidified air supply pipe 350 due to the flow of the air.

On the other hand, when an air guide hole is formed in the humidified air supply pipe 350, the air flows into the humidified air supply pipe 350 through the air guide hole, and the water vapor may flow into the humidified air supply pipe 350 from the humidified air supply tank 330. The water vapor then may be indirectly suctioned into the humidified air supply pipe 350 due to the flow of the air.

Meanwhile, the humidified air supply part 300 may include an upper flange 340 that is disposed on a lower side of the second accommodation tank 320 and the humidified air supply tank 330 to be integrally formed with the second accommodation tank 320 and the humidified air supply tank 330.

The upper flange 340 may connect the second accommodation tank 320 and the humidified air supply tank 330, and may extend to protrude outward to an outside of the second accommodation tank 320 and the humidified air supply tank 330 when viewed from the top.

The first accommodation tank 310 may include a lower flange 311 that supports the upper flange 340 while facing the upper flange 340. The lower flange 311 may be coupled to the upper flange 340 by a separate fastening member, or may be directly fused. The lower flange 311 may extend in a horizontal direction toward the outer side of the first accommodation tank 310 when viewed from the top so that the upper flange 340 and the lower flange 311 face each other.

The upper flange 340 and the lower flange 311 may be coupled to each other. Accordingly, the first accommodation tank 310, the second accommodation tank 320, and the humidified air supply tank 330 may be fixed to each other.

The humidified air supply part 300 may include a first sealing member 315 that is provided between the upper flange 340 and the lower flange 311 and is configured to seal the upper flange 340 and the lower flange 311 therebetween. The first sealing member 315 may extend in a circumferential direction of a rectangular shape to surround an interior space of the first accommodation tank 310 when viewed from the top.

The lower flange 311 may define a first sealing member groove 312 that is opened upward. The first sealing member groove 312 is formed between an inner circumference of the lower flange 311 and an outer circumference of the lower flange and may be recessed downward so that the first sealing member 315 is inserted thereinto. The first sealing member groove 312 may extend in a circumferential direction of a rectangular shape to surround an interior space of the first accommodation tank 310 when viewed from the top.

Due to this structure, it is possible to prevent the water or the water vapor in the first accommodation tank 310 from leaking to the outside between the first accommodation tank 310 and the second accommodation tank 320 or between the first accommodation tank 310 and the humidified air supply tank 330.

The humidified air supply part 300 may include a tank cover 323 that is disposed on an upper side of the second accommodation tank 320 to cover the second accommodation tank 320. The tank cover 323 may include a cover flange 324 that is configured to be coupled to the second accommodation tank 320. The cover flange 324 may extend in a horizontal direction toward the outside of the tank cover 323 at a lower portion of the tank cover 323.

The second accommodation tank 320 may include a fixing flange 324 that supports the cover flange 324 while facing the cover flange 324. The fixing flange 321 may be coupled to the cover flange 324 by a separate fastening member, or may be directly fused. The fixing flange 321 may extend in a horizontal direction toward the outside of the second accommodation tank 320 at an upper portion of the second accommodation tank 320.

The cover flange 324 and the fixing flange 321 may be coupled to each other. Accordingly, the tank cover 323 may be coupled to the second accommodation tank 320, and an interior space of the second accommodation tank 320 may be closed.

The humidified air supply part 300 may include a second sealing member 325 that is disposed between the tank cover 323 and the second accommodation tank 320 and is configured to seal a space between the tank cover 323 and the second accommodation tank 320. The second sealing member 325 may extend in a circumferential direction of a rectangular shape to surround an interior space of the second accommodation tank 320 when viewed from the top.

The fixing flange 321 may define a second sealing member groove 322 that is formed between an inner circumference and an outer circumference of the fixing flange 321 and is recessed downward so that the second sealing member 325 is inserted thereinto. The second sealing member groove 322 may extend in a circumferential direction of a rectangular shape to surround an interior space of the second accommodation tank 320 when viewed from the top.

Due to this structure, it is possible to prevent the water in the second accommodation tank 320 from leaking to the outside through the space between the second accommodation tank 320 and the tank cover 323.

The humidified air supply part 300 may include a water level sensing sensor 326 that is provided in the second accommodation tank 320 and is configured to sense a level of the water in the second accommodation tank 320. The water level sensing sensor 326 may pass through the tank cover 323 to flow into the second accommodation tank 320.

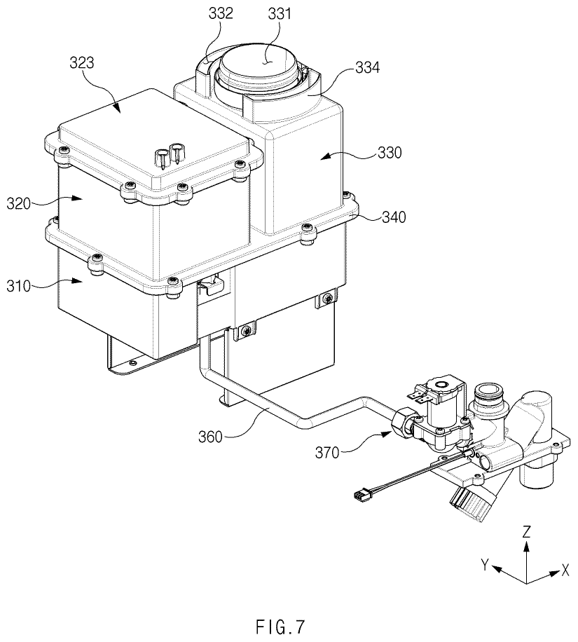

FIG. 7 is a perspective view of a first accommodation tank, a second accommodation tank, a supply pipeline, and a supply valve of a humidified air supply part according to an embodiment of the present disclosure.

Referring to FIG. 7, the humidified air supply part 300 (see FIG. 2) may include a supply pipeline 360 that communicates with the second accommodation tank 320 at one end thereof, and a supply valve 370 that is provided at an opposite end of the supply pipeline 360 to supply the water to the supply pipeline 360.

The processor of the second control panel 420 may control the supply valve 370 to supply the water to the second accommodation tank 320 through the supply pipeline 360 when the level of the water in the second accommodation tank 320, which is sensed by the water level sensing sensor 326 (see FIG. 6), is less than a specific second height.

The supply valve 370 may be connected to a separate external water source, or may be connected to the water that is introduced into the water heater 100 and is heated and discharged.

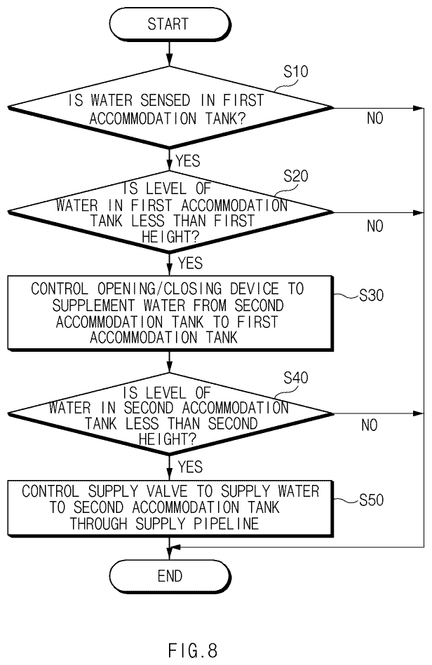

FIG. 8 is a flowchart of an operation of supplementing water to a first accommodation tank and a second accommodation tank according to an embodiment of the present disclosure.

Referring to FIGS. 5 and 8, the processor of the second control panel 420 (see FIG. 2) may determine whether water is sensed in the first accommodation tank 310 by the water level adjusting valve 313 (S10)

When water is sensed in the first accommodation tank 310 (Yes in S10), the processor may determine whether the level of the water in the first accommodation tank 310, which is sensed by the water level adjusting valve 313, is less than the first height (S20).

When the level of the water in the first accommodation tank 310 is less than the first height (Yes in S20), the opening/closing device 314 (see FIG. 5) may be controlled or operated to supplement water from the second accommodation tank 320 to the first accommodation tank 310 (S30).

Thereafter, the processor may determine whether the level of the water in the second accommodation tank 320, which is sensed by the water level sensing sensor 326, is less than the second height (S40).

When the level of the water in the second accommodation tank 320 is less than the second height (Yes in S40), the processor may control the supply valve 370 to supply water to the second accommodation tank 320 through the supply pipeline 360 (FIG. 7).

According to this control structure, even when water is not separately supplied to the humidified air supply part 300 of the water heater 100, the humidity of the air supplied to the burner 230 may be maintained in a relatively high state, so that a concentration of nitrogen oxide in the exhaust gas that is exhausted to the outside of the water heater 100 through the air discharge hole 112 may be maintained in a reduced state.

When no water is sensed in the first accommodation tank 310 (No in S10), when the level of the water in the first accommodation tank 310 is the first height or more (No in S20), or when the level of the water in the second accommodation tank 320 is the second height or more (No in S30), the processor may not perform a separate control.

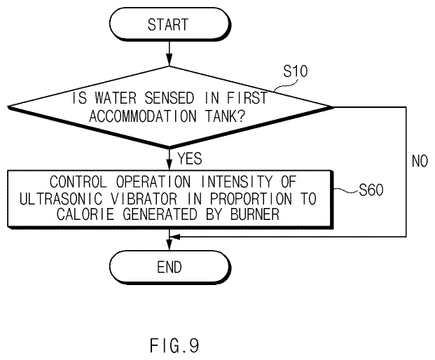

FIG. 9 is a flowchart of an operation of controlling an operation intensity of an ultrasonic vibrator according to an embodiment of the present disclosure.

Referring to FIGS. 5 and 9, the processor of the first control panel 410 (see FIG. 2) may determine whether water is sensed in the first accommodation tank 310 by the water level adjusting valve 313 (S10)

When water is sensed in the first accommodation tank 310 (Yes in S10), the processor may control an operation intensity of the ultrasonic vibrator in proportion to a calorie of the water vapor, which is generated by the burner 230 (S60).

That is, in other words, when the burner 230 generates a relatively high calorie, more water vapor may be generated in the first accommodation tank 310. On the other hand, when the burner 230 generates a relatively low calorie, less water vapor may be generated in the first accommodation tank 310.

This is because, when the burner 230 generates a high calorie, more air may be introduced into the burner 230, so that more water vapor for the combustion reaction needs to be supplied to the burner 230.

When water is not sensed in the first accommodation tank 310 (No in S10), the processor may not perform a separate control.

The first control panel 410 and the second control panel 420 described above may be provided separately, or may be provided as a single control panel.

According to an embodiment of the present disclosure, because air is introduced into the burner in a humidified state, a combustion reaction may be caused in the burner, and thus, the nitrogen oxide emitted from the burner may be reduced.

According to an embodiment of the present disclosure, the water may be prevented from flowing into the humidified air supply pipe from the first communication tank due to the humidified air supply tank of the humidified air supply part.

According to an embodiment of the present disclosure, when the level of the water in the first accommodation tank and the second accommodation tank is lowered, water may be supplemented to the first accommodation tank and the second accommodation tank, so that convenience of the water heater may be improved.

According to an embodiment of the present disclosure, because the water vapor may be generated in the first accommodation tank in proportion to the calorie generated by the burner, an amount of the nitrogen oxide discharged from the burner may be efficiently reduced.

The above description is merely an example of the technical idea of the present disclosure, and various modifications and variations may be made by one skilled in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A water heater comprising:
a case provided with an air supply hole and an air discharge hole;
a burner provided in an interior of the case; and
a humidified air supply part configured to provide humidified air to the burner together with a fuel,
wherein the humidified air supply part includes:
a first accommodation tank configured to accommodate water to generate vapor; and
a humidified air supply tank configured to provide a space for supplying the vapor supplied from the first accommodation tank to air introduced into an interior of the case through the air supply hole.

2. The water heater of claim 1, wherein the humidified air supply part further includes:
an ultrasonic vibrator configured to apply ultrasonic waves to the water in the first accommodation tank.

3. The water heater of claim 2, further comprising:
a processor configured to, control an intensity of an operation of the ultrasonic vibrator to generate the vapor in proportion to a calorie generated due to the burner in response that the water is sensed in the first accommodation tank.

4. The water heater of claim 2, wherein the humidified air supply part further includes:
a second accommodation tank disposed on an upper side of the first accommodation tank, and configured to supplement the water to the first accommodation tank.

5. The water heater of claim 4, wherein the humidified air supply part further includes:
a water level adjusting valve provided in the first accommodation tank and configured to sense and adjust a level of the water in the first accommodation tank; and
an opening/closing device configured to open and close an outlet of the second accommodation tank, the outlet communicating with the first accommodation tank and
wherein the opening/closing device is operated to supplement the water from the second accommodation tank to the first accommodation tank in response that the level of the water sensed by the water level adjusting valve is less than a first height.

6. The water heater of claim 5, wherein the humidified air supply part further includes:
a water level sensing sensor provided in the second accommodation tank, and configured to sense a level of the water in the second accommodation tank;
a supply pipeline communicating with the second accommodation tank at a first end of the supply pipeline; and
a supply valve provided at a second end of the supply pipeline, and configured to supply the water to the supply pipeline, and
wherein the processor controls the supply valve to supply water to the second accommodation tank through the supply pipeline in response that the level of the water sensed by the water level sensing sensor is less than a second height.

7. The water heater of claim 4, wherein the humidified air supply tank is disposed on an upper side of the first accommodation tank on one side of the second accommodation tank,
wherein the humidified air supply tank further includes:
a fuel supply part configured to receive the humidified air from the humidified air supply tank and supply the air and the fuel to the burner, and
wherein the humidified air supply part further includes:
a humidified air supply pipe extending from the humidified air supply tank to the fuel supply part.

8. The water heater of claim 7, wherein the humidified air supply tank defines a humidified air communication hole communicating with the humidified air supply pipe, and an air introduction hole spaced apart from the humidified air communication hole and extending to surround the humidified air communication hole.

9. The water heater of claim 8, wherein the humidified air supply tank further includes:
a cover rib defining a circumference of the air introduction hole and protruding upward from an upper surface of the humidified air supply tank.

10. The water heater of claim 7, wherein the humidified air supply part further includes:
an upper flange disposed on a lower side of the second accommodation tank and on a lower side of the humidified air supply tank and integrally formed with the second accommodation tank and the humidified air supply tank, and
wherein the first accommodation tank further includes:
a lower flange configured to support the upper flange while facing the upper flange.

11. The water heater of claim 10, wherein the humidified air supply part further includes:
a first sealing member provided between the upper flange and the lower flange, and configured to seal the upper flange and the lower flange therebetween.

12. The water heater of claim 11, wherein the lower flange defines a first sealing member groove formed between an inner circumference and an outer circumference of the lower flange, and recessed downward such that the first sealing member is inserted into the first sealing member groove.

13. The water heater of claim 4, wherein the humidified air supply part further includes:
a tank cover disposed on an upper side of the second accommodation tank and covering the second accommodation tank; and
a second sealing member disposed between the tank cover and the second accommodation tank, and configured to seal the tank cover and the second accommodation tank therebetween.

14. The water heater of claim 13, wherein the tank cover includes a cover flange configured to be coupled to the second accommodation tank, and
wherein the second accommodation tank includes a fixing flange configured to support the cover flange while facing the cover flange.

15. The water heater of claim 14, wherein the fixing flange defines a second sealing member groove formed between an inner circumference and an outer circumference of the fixing flange, and recessed downward such that the second sealing member is inserted into the second sealing member groove.

16. The water heater of claim 7, wherein an air guide hole for introducing the air introduced into the case is formed in the humidified air supply pipe.

17. The water heater of claim 1, further comprising:
a fuel supply part configured to receive the humidified air from the humidified air supply tank and supply the air and the fuel to the burner,
wherein the fuel supply part is formed by a venturi pipe.

18. The water heater of claim 17, further comprising:
a mixing chamber disposed between the fuel supply part and the burner, and configured to mix the fuel and the air;
a blower fan housing disposed between the fuel supply part and the mixing chamber; and
a blower fan mounted in an interior of the blower fan housing such that the fuel and the air flow from the fuel supply part to the mixing chamber.
